(19) United States
(12) Patent Application Publication
(10) Pub. No.: US 2017/0309914 A1
(43) Pub. Date: Oct. 26, 2017

(54) PRE-LITHIATED LITHIUM ION BATTERY CELL

(71) Applicant: FORD GLOBAL TECHNOLOGIES, LLC, Dearborn, MI (US)

(72) Inventors: Andrew Robert Drews, Ann Arbor, MI (US); Mohan Karulkar, Dearborn, MI (US)

(21) Appl. No.: 15/133,308

(22) Filed: Apr. 20, 2016

(51) Int. Cl. H01M 4/62; H01M 10/0525; H01M 4/36; H01M 4/02

(52) U.S. Cl. CPC H01M 4/62; H01M 10/0525; H01M 4/362; H01M 2004/028; H01M 2004/021

(57) ABSTRACT

A lithium ion battery cell includes an anode, a cathode, and a sacrificial lithium-containing material on the cathode configured to decompose to release lithium ions in response to first application of charge current to the cell to prompt formation of a solid-electrolyte interphase via a reaction of the lithium ions on a surface of the anode adjacent to the cathode.

### TECHNICAL FIELD

The present disclosure is related to a lithium ion battery cell and a process to make the same.

### BACKGROUND

Lithium ion batteries present a rechargeable electrochemical storage technology. Due to the electrochemical potential and theoretical capacity provided by the lithium ion batteries, the technology shows promise regarding electrification of the drivetrain and providing stationary storage solutions to enable effective use of renewable sources of energy. Lithium ion batteries produce electricity by means of a cathode, an anode, and an electrolyte which connects and separates the two electrodes. Lithium ions migrate via the electrolyte from one electrode to the other while associated electrons are being collected by current collectors and may serve as an energy source for an electric device. Yet, upon the first application of the charge current to the battery, a solid-electrolyte interphase (SEI) layer is formed on the anode. The first charging cycle typically follows a sophisticated protocol to enhance the performance, cycling, and service life of the battery. The formation of the SEI is necessary for the correct function of the battery, but is connected with the loss of cycleable lithium from the battery, which leaves the battery's capacity depleted.

### SUMMARY

According to one embodiment, a lithium ion battery cell is disclosed. The battery cell includes an anode, a cathode, and a sacrificial lithium-containing material on the cathode. The sacrificial lithium-containing material is configured to decompose in response to first application of charge current to the cell. The decomposition releases lithium ions to prompt formation of a solid-electrolyte interphase via a reaction of the lithium ions on a surface of the anode adjacent to the cathode. The sacrificial lithium-containing material may be arranged between the cathode and a cathode current collector. Alternatively, the sacrificial lithium-containing material may be arranged between the cathode and a separator. The sacrificial lithium-containing material may be an oxidized lithium compound configured to decompose into a gas and the lithium ions in response to the first application of charge current. The oxidized lithium compound may be lithium peroxide. The battery cell may further comprise a catalyst configured to initialize a decomposition of the sacrificial lithium-containing material. The catalyst may be cobalt tetraoxide. The amount of the sacrificial lithium-containing material may correspond to a theoretical amount of lithium to be consumed by the solid-electrolyte interphase formation during a first battery cell charge cycle.

In an alternative embodiment, another lithium ion battery cell is disclosed. The battery cell includes an anode and a cathode including sacrificial lithium-containing material. The sacrificial lithium-containing material is configured to decompose in response to first application of charge current to the cell. The decomposition releases lithium ions to prompt formation of a solid-electrolyte interphase via a reaction of the lithium ions on a surface of the anode adjacent to the cathode. The sacrificial lithium-containing material may be an oxidized lithium compound configured to decompose into a gas and the lithium ions in response to the first application of charge current. The cathode may comprise cavities, at least some of which may include the sacrificial lithium-containing material. The battery cell may further comprise a catalyst configured to initialize a decomposition of the sacrificial lithium-containing material. The catalyst may be cobalt tetraoxide. The amount of the sacrificial lithium-containing material may correspond to a theoretical amount of lithium to be consumed by the solid-electrolyte interphase formation during a first battery cell charge cycle.

In a yet another embodiment, a lithium ion battery cell is disclosed. The battery cell includes an anode and a cathode having a porous structure impregnated with a sacrificial lithium-containing material. The sacrificial lithium-containing material may be configured to decompose to release lithium ions in response to first application of charge current to the cell to prompt formation of a solid-electrolyte interphase via a reaction of the lithium ions on a surface of the anode adjacent to the cathode. The amount of the sacrificial lithium-containing material may correspond to a theoretical amount of lithium to be consumed by the solid-electrolyte interphase formation during a first battery cell charge cycle. The sacrificial lithium-containing material may be an oxidized lithium compound configured to decompose into a gas and the lithium ions in response to the first application of charge current. The oxidized lithium compound may be lithium peroxide. The decomposition of the sacrificial lithium-containing material may increase volume of pores within the porous structure of the cathode. The battery cell may further comprise a catalyst to initialize a decomposition of the sacrificial lithium-containing material.

### BRIEF DESCRIPTION OF THE DRAWINGS

FIG. 1 depicts a schematic diagram of the lithium ion migration through an electrolyte during charge and discharge and the intercalation principal within a lithium ion battery cell in accordance with one or more embodiments;

FIG. 2 shows a schematic view of an example lithium ion battery cell having a solid-electrolyte interphase on the anode;

FIG. 3A depicts a schematic view of an example lithium ion battery cell including a sacrificial lithium-containing material between the cathode and the separator;

FIG. 3B depicts a schematic view of an example lithium ion battery cell including a sacrificial lithium-containing material adjacent to the cathode;

FIG. 4A illustrates an example porous cathode material including an active material, storage material, and sacrificial lithium-containing material;

FIG. 4B illustrates a cross section view taken along line 4B-4B of FIG. 4A showing a sacrificial lithium-containing material within the pores enclosed within the cathodic material;

FIG. 4C illustrates a cross section view taken along line 4C-4C of FIG. 4A showing the pores, enclosed within the cathodic material, being free of the sacrificial lithium-containing material;

FIG. 5 depicts a number of plots showing electrode calendaring density needed to achieve final porosity for different first cycle loss percentages;

FIG. 6 show a number of plots illustrating the impact of varying a ratio of specific capacity of active material to the sacrificial lithium-containing material with a first cycle loss fixed at 20%;

FIG. 7 is a graph illustrating voltage profiles of an electrode A having no sacrificial lithium-containing material and an electrode B containing Li₂O₂ as a sacrificial lithium-containing material; and

FIG. 8 is a graph illustrating rate capability profiles for an electrode A having no sacrificial lithium-containing material and an electrode B containing Li₂O₂ as a sacrificial lithium-containing material.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Except where expressly indicated, all numerical quantities in this description indicating amounts of material or conditions of reaction and/or use are to be understood as modified by the word “about” in describing the broadest scope of the present invention.

The first definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

The description of a group or class of materials as suitable for a given purpose in connection with one or more embodiments of the present invention implies that mixtures of any two or more of the members of the group or class are suitable. Description of constituents in chemical terms refers to the constituents at the time of addition to any combination specified in the description, and does not necessarily preclude chemical interactions among constituents of the mixture once mixed. The first definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

A lithium-ion battery is a rechargeable battery used in consumer electronics such as portable electronics as well as in battery electric vehicles and aerospace applications. The lithium-ion battery has a relatively high energy density, small memory effect, and low self-discharge. An additional advantage of the lithium-ion battery is its low weight.

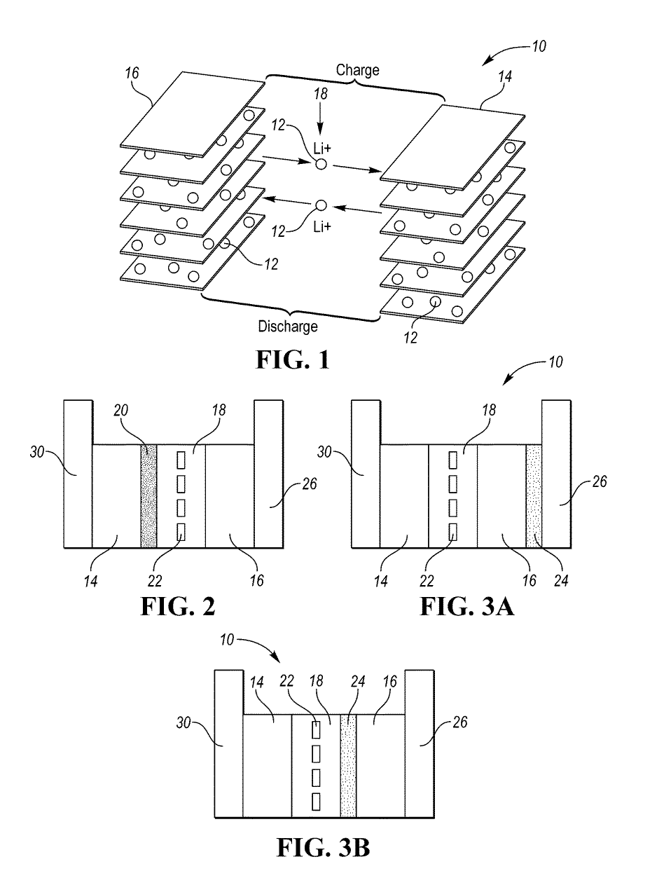

Each lithium-ion battery includes two electrodes, the anode and the cathode, a non-aqueous electrolyte which enables ionic movement of lithium between the two electrodes, and a separator diaphragm. As is schematically depicted in FIG. 1, the electrodes have open or porous structures allowing for an insertion and extraction of lithium ions as well as accepting compensating electrons at the same time. The principal of the lithium-ion rechargeable battery 10 thus lies in migration of the lithium ions 12, which carry the current, from the anode 14 to the cathode 16 during discharge. During charging, an external electrical power source (not depicted) applies an over-voltage to the cell 10, forcing the electric current to pass in the reverse direction. The lithium ions 12 thus migrate via electrolyte 18 from the cathode 16 to the anode 14, where they are stored in the anodic material 14. This mechanism, incorporating intercalation, includes the insertion of lithium ions into the structure of the electrodes 14, 16 without changing the electrodes' structures.

Several types of lithium-ion batteries have been developed. Exemplary types include batteries based on cathodes containing lithium cobalt oxide (LiCoO₂), lithium ion phosphate (LiFePO₄), lithium manganese oxide (LiMnO), lithium nickel manganese cobalt oxide (Li (NiₓMn_{y}Co_{1-x-y})O₂), or the like. Unlike lithium metal batteries, the lithium-ion batteries typically use graphite as the active material in the anode, which intercalates lithium ions.

During the initial charging of a new lithium-ion battery cell 10, a fraction of the lithium liberated from the cathode 16 is consumed to form the SEI 20 on the anode 14, which is depicted in FIG. 2. The SEI 20 helps to provide stability to the lithium battery cell 10 with a carbon-based anode 14. The amount of the consumed lithium may be up to about 10-50%, 20 to 45%, or 30 to 40% of the lithium contained within the cathode 16. Certain materials such as silicon and silicon composites are especially prone to consuming a relatively large amount of lithium from the cathode 16 to form the SEI, for example about 20-40% of the lithium in response to the first application of charge current to the cell 10. Because the lithium released by the cathode 16 is consumed to form the SEI 20, the lithium cannot be recovered and thus presents a permanent loss of lithium from the battery cell 10. The loss translates into a loss of available capacity for cycling.

Several solutions to the permanent loss of lithium in the cell have been proposed. For example, a method of physically prelithiating the anode has been developed. The method proposes placing the anode in direct contact with lithium metal for a specific period of time. After prelithiation, the electrode is assembled into the cell in a conventional manner. The method is; however, relatively imprecise and impractical for large anode areas of non-research cells such as pouch, prismatic, and cylindrical cells.

Including a sacrificial lithium electrode to the cell presents an alternative method. The sacrificial electrode is sized precisely to balance the lithium to be lost due to the SEI formation. The sacrificial electrode is connected at the cathode during the first charge cycle and disconnected after the SEI forms. This method has a number of disadvantages. Just as the prelithiated anode, this solution is relatively impractical for large-format cells, which often involve initial assembly in oxygen-containing environments that are not safe for lithium handling. Additionally, relatively large pieces of lithium may have to be included which introduces additional safety hazards. The addition of a separate lithium electrode also undesirably increases the cost and spatial requirements of the battery cell system.

Therefore, it would be desirable to provide a source of extra lithium to the battery cell system 10 such that the first-cycle SEI formation does not leave the cathode 16 depleted. A lithium ion battery cell 10 solving one or more of the above-mentioned disadvantages is presented herein. As is depicted in FIGS. 3A and 3B, the battery cell 10 includes an anode 14 and a cathode 16 connected and separated by an electrolyte 18 and divided by a separator 22. A sacrificial lithium-containing material 24 is added to the system 10. The sacrificial lithium-containing material 24 is configured to decompose to release lithium ions in response to the first application of charge current to the cell 10. The decomposition prompts formation of the SEI 20 via reaction of the lithium ions on a surface of the anode 14. The SEI 20, formed as a passivating layer on the anode 14, is depicted in FIG. 2.

As can be seen in FIG. 3A, the sacrificial lithium-containing material 24 may be arranged between the cathode 16 and a cathode current collector 26. Alternatively, as is depicted in FIG. 3B, the sacrificial lithium-containing material 24 may be arranged between the cathode 16 and the separator 22. In these embodiments, the sacrificial lithium-containing material 24 may be added to the cell system 10 as a separate layer adjacent to the cathode 16.

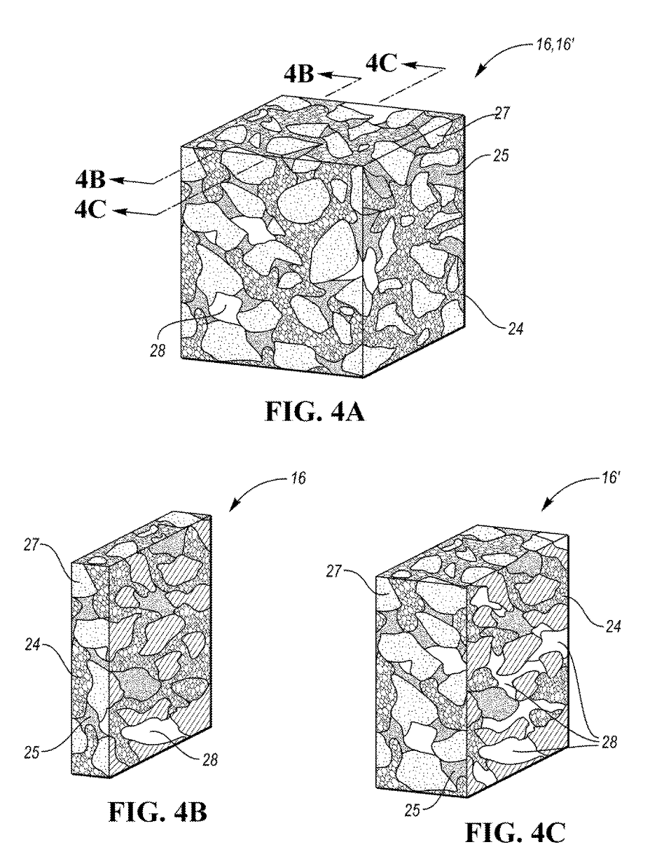

Alternatively, the sacrificial lithium-containing material 24 may be mixed into a cathode slurry and co-deposited in the same coating step as the cathodic material. The sacrificial lithium-containing material 24 may thus occupy spaces within the cathodic material 16 which would otherwise form cavities 28 in the cathodic material 16. At least some cavities 28 remain free of the sacrificial lithium-containing material 24 so that the cathode 16 has desirable porosity. When the sacrificial lithium-containing material 24 is intermixed directly with the cathode slurry, the cavities 28 deep within the cathode 16 may be filled with the sacrificial lithium-containing material 24, as can be seen in FIG. 4B, depicting a cross-sectional view of the cathode 16 of FIG. 4A. The sacrificial lithium-containing material 24 may be thus enclosed within the mass of the cathodic material 16. The sacrificial lithium-containing material 24 may form agglomerations, aggregations, clusters, the like, or a combination thereof within the cathodic material 16. Alternatively, individual molecules of the sacrificial lithium-containing material 24 may be enclosed within the cathodic material 16.

Alternatively, a cathode 16′ may be formed without the sacrificial lithium-containing material 24. Such prefabricated cathode 16′ may be then impregnated with the sacrificial lithium-containing material 24 and dried in situ. In this embodiment, some of the existing porosity within the fabricated cathodic material may be filled with the sacrificial lithium-containing material 24. But some of the pores or cavities 28 may be enclosed within the mass of the cathodic material 16 and thus may not be accessible for the purpose of impregnation. The sacrificial lithium-containing material 24 may be inserted within the cavities 28 which are accessible. Thus, any inaccessible cavities 28 of the prefabricated cathode 16′ may remain free of the sacrificial lithium-containing material 24, as is depicted in FIG. 4C.

Porosity is needed to provide spaces in which the electrolyte can exist within the cell 10. A desirable extent of porosity depends on a number of factors such as the operation of the battery cell 10. A battery cell 10 to be discharged over a relatively long period of time may have lower porosity than a battery cell 10 to be discharged in a short period of time. The porosity of the electrode may be about 25-30%. As the sacrificial lithium-containing material 24 is being discharged from the cathodic material 16, additional voids are created within the cathodic material 16. Since the decomposition provides additional porosity, the cathode 16 may be designed as “under porous” when fabricated. Only after the discharge of the sacrificial lithium-containing material 24, the desired amount of cavities 28 is thus gained in the cathodic material 16. The under-porosity may be achieved by controlling the amount of solvent in the cathodic slurry, adjusting the speed of solvent evaporation from the cathodic slurry, or the like. The relative amount of under-porosity of the cathodic material may be about 10% to 40%, 15% to 30%, or 18% to 25%.

Alternatively still, the porosity may be controlled by an adjustment of the calendaring step post-fabrication of the electrode. For example, the release of the sacrificial lithium-containing material 24 may provide extra porosity. Thus, a higher degree of calendaring may remove some of the created porosity as the extra pressure is applied to the electrode. Calendaring is usually implemented to improve adhesion between layers of the cell 10. Higher degree of calendaring may decrease porosity and increase adhesion while lower degree of calendaring could be applied to keep the porosity at a certain preexisting level. The percentage of the final porosity may be determined based on the amount of extra lithium to be released from the cathode 16.

Adding any material to the electrode requires consideration of the impact of such addition on the final porosity of the electrodes. In at least one embodiment, the source of the sacrificial lithium-containing material 24 may be lithium peroxide (Li₂O₂), which is incorporated into the cathode 16 during fabrication and decomposed during the first charge to form Li ions and oxygen gas. After the initial formation, the battery cell 10 is degasses, removing the liberated oxygen and any other gaseous products of the irreversible reactions. By incorporating Li₂O₂ in the cathode 16, the porosity of the cathode 16 is initially partially filled with Li₂O₂. After the first charge, Li₂O₂ is absent, leaving behind open porosity which is filled with liquid electrolyte 18. Depending on the application, the final porosity is a very important feature of the cell design as it influences the rate capability of the cell 10. Altering the porosity of the electrodes 14, 16 is difficult after the battery cell 10 is assembled so achieving the desired final porosity requires careful engineering of the density of the calendared, un-cycled electrodes.

For battery cell chemistries that experience large first-cycle losses, larger amount of lithium-containing sacrificial material 24 is needed to compensate for the lithium loss than in cells with lesser first-cycle losses. The sacrificial lithium-containing material 24 presents additional material which may occupy a significant volume fraction of the cathode 16 or even exceed the design goal for final porosity. In this case, alternate strategies may be needed. For example, an applied over-layer of the sacrificial lithium-containing material 24 may provide the lithium needs without requiring electrode porosity to contain the sacrificial lithium-containing material 24. On decomposition of the sacrificial lithium-containing material 24, the battery cell 10 compression can be utilized to bring the cell separators 22 and the cathode 16 back into intimate contact. This may occur during the cell degassing operation without having to incorporate any addition steps. If the sacrificial lithium-containing material 24 is incorporated into the cathode 16, either as a filler applied after fabrication or in-situ as part of the cathode slurry, then consideration of the electrode density and target final porosity is required.

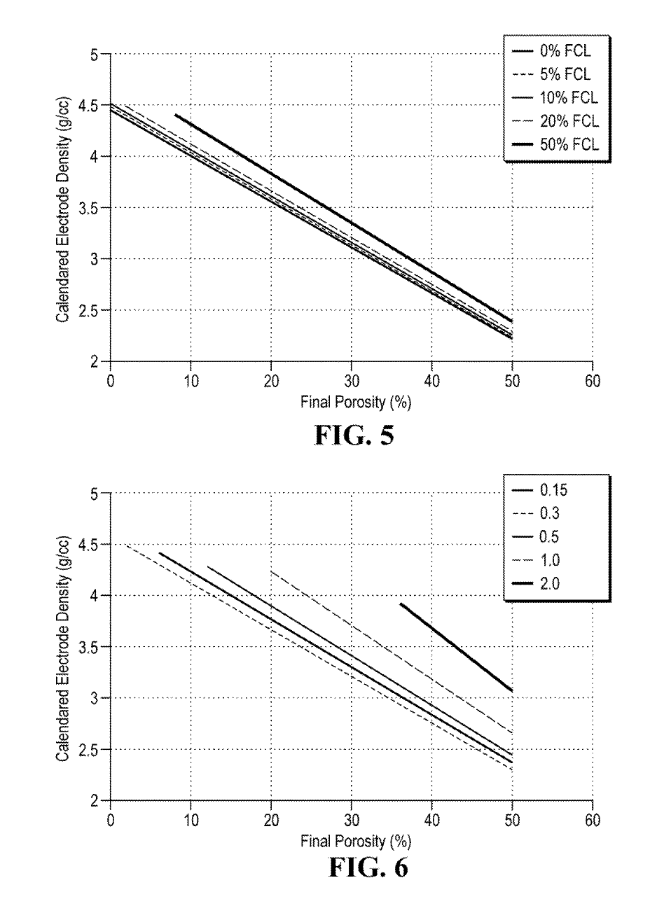

Example calendar densities are given in FIGS. 5 and 6 for a NMC cathode loaded with Li₂O₂ to compensate for a first-cycle loss (FCL). Parameters used are given in Table 1 and plots of constant FCL with relation to calendared electrode density and final electrode porosity are shown in FIG. 5. The cathode active material is a hypothetical NMC with PVDF binder and amorphous carbon conductive additive. The sacrificial material is Li₂O₂.

TABLE 1
Material and other properties used to estimate the density/porosity/first
cycle loss for curves in FIGS. 5 and 6

| Property | Value and unit | |
|---|---|---|
| Cathode specific capacity | 185 | mAh/g |
| Specific capacity of the sacrificial material | 1168 | mAh/g |
| Cathode crystal density | 4.78 | g/cm³ |
| Density of the binder | 1.78 | g/cm³ |
| Density of the conductive carbon | 2.3 | g/cm³ |
| Density of the sacrificial material | 2.31 | g/cc |

| | |
|---|---|
| Binder volume percentage | 3% of cathode volume |
| Conductive carbon volume percentage | 3% of cathode volume |
| Active material (solids) volume percentage | 94% of cathode volume |

FIG. 5 depicts possible electrode calendared density versus final porosity for an NMC cathode including lithium peroxide for various FCL percentages. The curves are terminated at the theoretical (100%) density of the composite electrode. In actual practice, the termination is likely of the order of 75% of theoretical density, but can vary depending on materials used.

FIG. 6 illustrates possible electrode calendared density vs. final porosity for various values of SC_{AM}/SC_{SM}, where SC_{SM} and SC_{AM} are respective specific capacities of the lithium-containing sacrificial material SC_{SM} and active materials SC_{AM} in (mAh/g), and FCL is the fraction of area capacity lost in the first cycle. In FIG. 6, the FCL is fixed at 20%. Using lower capacity lithium-containing sacrificial materials has the effect of limiting the minimum achievable final porosity.

Thus, the sacrificial lithium-containing material 24 serving as a source of extra lithium for the anode 14 can be added in a precise amount to compensate for the predictable loss of lithium during the first charge cycle of the battery cell 10. The sacrificial lithium-containing material 24 should be compatible with the cathodic material 16 and with the slurry coating process. The sacrificial lithium-containing material 24 may form compounds which are easily removable from the cell 10. For example, as was discussed above, the sacrificial lithium-containing material 24 may decompose into lithium ions which form the SEI 20 and into a gas which is removable via degassing or venting. After the SEI 20 is formed, the cell 10 is conventionally subjected to degassing. Therefore, adding a sacrificial lithium-containing material 24 which decomposes into a gas utilizes an already existing process. Additionally, a sacrificial lithium-containing material 24 which decomposes into a removable gas and lithium ions adds no additional weight to the cell 10, besides the needed lithium. Moreover, the sacrificial lithium-containing material 24, and its decomposition product or products, should be free of a substance which could cause chemical degradation of the battery cell 10. The sacrificial lithium-containing material 24 should not react with lithium. It is contemplated that the sacrificial lithium-containing material 24 may decompose into a variety of products besides the lithium ions and a gas. Yet, the sacrificial lithium-containing material 24 should be chosen so that safety risks are not increased. For example, it is undesirable that the decomposition of the sacrificial lithium-containing material 24 should create water, as water is reactive with lithium and may cause safety hazards or decrease the durability of the cell 10. Additionally, the sacrificial lithium-containing material 24 is tailored so that the sacrificial lithium-containing material 24 is decomposed at a voltage compatible with safe operation of the cell. Exemplary voltage may be up to 4.6 V during the first cycle.

Exemplary sacrificial lithium-containing materials 24 include lithium oxides, lithium salts such as LiF, lithium peroxides such as Li₂O₂, lithium hydrides, lithium nitrates, lithium carbonates, the like, or a combination thereof.

The electrolyte intermingles with the electrode particles to allow for ionic transfer of lithium ions from the separator 22 into the depths of the electrodes 14, 16. A liquid electrolyte may contain one or more solvents and a dissolved lithium-containing salt. While many options exist regarding the choice of electrolyte material 18, not all sacrificial lithium-containing materials 24 are compatible with every electrolyte component. Therefore, the choice of the sacrificial lithium-containing material 24 determines the type of electrolyte material 18 to be implemented in the battery cell 10, and vice versa. For example, if lithium peroxide (Li₂O₂) is chosen as the sacrificial lithium-containing material 24, a carbonate electrolyte solvent may react with the Li₂O₂ to form Li₂CO₃, which may be undesirable.

The electrolyte material 18 may be liquid, semi-liquid, or solid. The electrolyte material 18 may be organic. The electrolyte material 18 may contain a carbonate solvent such as ethylene carbonate, dimethyl carbonate, diethyl carbonate, propylene carbonate, or other organic carbonates, or include a mixture of various carbonate solvents. In addition, the electrolyte material 18 may contain non-carbonate solvents such as dimethoxyethane (C₄H₁₀O₂), butyrolactone (C₄H₆O₂), methylbutyrate (C₅H₁₀O₂), perfluoropolyether (PFPE), tetrahydrofuran (THF), ionic liquids, or their combination, or include a combination or non-carbonate and carbonate solvents. For example, the electrolyte 18 may include about 1-99% of one type of a carbonate electrolyte solvent and the remainder may be at least one different type of a non-carbonate electrolyte solvent.

Solid electrolyte may also be used such that the lithium conduction is via solid materials. Examples of solid electrolytes may include lithium lanthanum zirconium oxide (Li₇La₃Zr₂O₁₂), lithium titanium lanthanum oxide (Li_{0.5}La_{0.5}TiO₃), lithium zinc germanium oxide (Li₂₊₂ₓZn₁₋ₓGeO₄), lithium phosphorous oxynitride (Li₂PO₂N), the like, or a combination thereof. Alternatively still, a combination of solid electrolytes and liquid electrolytes, such as those named above, may be used.

An exemplary electrolyte, effective in the combination with Li₂O₂, may include about 50% propylene carbonate and about 50% dimethoxyethane. This combination electrolyte may be especially useful in preventing formation of Li₂CO₃, which may be a problem if carbonate electrolyte solvents like ethylene carbonate, diethyl carbonate, dimethyl carbonate, etc. would be used for Li₂O₂ as the sacrificial lithium-containing material 24.

In addition to solvents, the liquid electrolyte material 18 may contain a lithium containing salt, such as lithium hexafluorophosphate (LiPF₆), lithium perchlorate (LiClO₄), the like, or a combination thereof. An exemplary electrolyte used in Li-ion battery cells 10 may contain about 1M LiPF₆ salt dissolved in a 3:7 mixture of ethylene carbonate:dimethyl carbonate.

The material of the anode 14 may be carbon-based. The carbonaceous anode 14 may include graphite as the lithium storage material 25. The carbon additive 25 may be used to enhance electronic conductivity of the electrode 14. In addition, the carbon additive 25 may coat the active material particles 27 with a loose, porous layer. Alternatively, lithium storage may be realized via alloying reactions (e.g., tin, silicone, the like), or through displacement reactions with compounds such as metal oxides, metal fluorides, metal nitrides, the like, or a combination thereof. The anode material 14 may include allotropes of carbon such as graphite in combination with carbon black, carbon nanotubes, graphene fullerenes, bucky structures, nanocones, or the like.

The cathodic material 16 may include intercalation metal oxides such as lithium oxides including lithium cobalt oxide (LiCoO₂), and lithium manganese dioxide (LiMn₂O₄), vanadium oxides, olivines such as LiFePO₄, lithium nickel manganese cobalt oxide (Li(Ni_{1-x-y} MnₓCo_{y})O₂), the like, or a combination thereof. In at least one embodiment, the cathodic material 16 may include elements or compounds capable of reversibly undergoing displacement reactions with lithium such as sulfur (2Li+S⇄Li₂S) or iron fluoride (3Li+FeF₃⇄Fe+3LiF). Numerous examples of reaction types and compounds are known to those skilled in the art, and the examples cited herein are non-exclusive of any known or yet to be discovered examples.

The current collectors 26 and 30, as depicted in FIGS. 2, 3A, and 3B are metallic foils. The type of foil used depends on a variety of factors such as the application of the battery cell 10, chemical and electrochemical stability of the collectors 26, 30, ability to form alloys with lithium, etc. The cathode foil may be the same or different than the anode foil. Exemplary cathode foils may include a rolled aluminum foil, copper foil, a stainless steel foil, titanium foil, an alloyed foil, or the like. Exemplary anode foils may include electrodeposited copper foils, nickel foils, rolled copper alloy foils, a stainless steel foil, a titanium foil, an alloyed foil, or the like.

In one or more embodiments, the initial decomposition of the sacrificial lithium-containing material 24 may be facilitated by an introduction of one or more catalysts. The choice of the catalyst material is dependent on the type of the sacrificial lithium-containing material 24 used. For example, when the sacrificial lithium-containing material 24 is Li₂O₂, the catalyst may be a heterogeneous catalyst in the form of dispersed cobalt tetraoxide (CO₃O₄), MnOₓ, or the like. Other elements or compounds that show catalytic activity for the decomposition reaction for the sacrificial lithium-containing material 24 such as platinum may be used, but may be less desirable due to high cost. In some embodiments, the catalyst may be a homogeneous catalyst dissolved in the liquid electrolyte material 18. In yet another embodiment, the active cathode material 16 may also have catalytic activity.

### Example

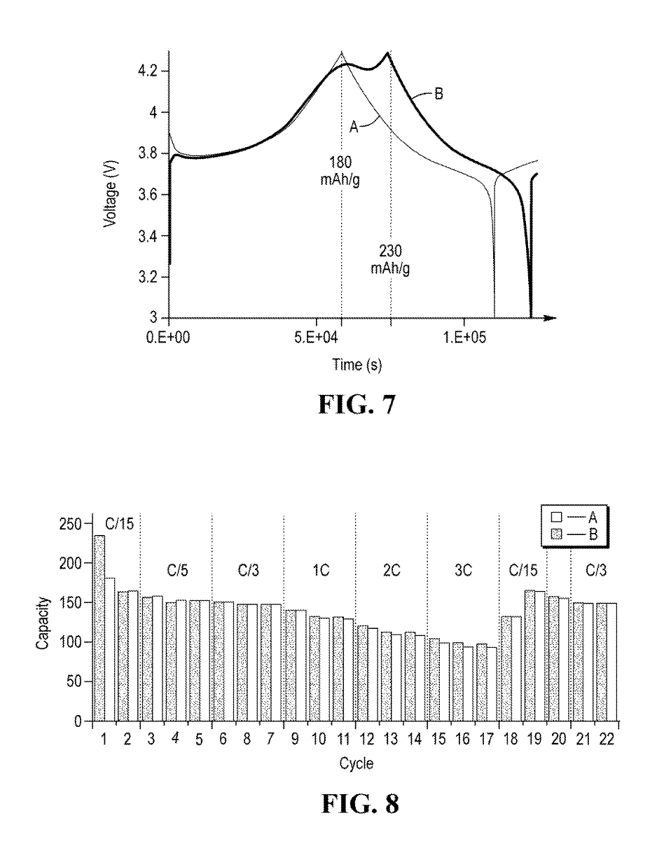

Two NMC electrodes A and B were prepared according to the method described below. Electrode A was prepared without the sacrificial lithium-containing material. Electrode B was prepared with Li₂O₂ as the sacrificial lithium-containing material. No catalyst was added to the electrodes. Voltage profiles of both electrodes were then studied. The results can be observed in FIGS. 7 and 8. In FIG. 7, an extra reaction hump can be seen in the B electrode including Li₂O₂, along with the accompanying extra available capacity in response to the first application of charge current. The specific capacity of electrode A was 180 mAh/g while the capacity of electrode B measured was 230 mAh/g during the first cycle. The first cycle capacity of the electrodes A and B depicted in FIG. 7 corresponds to the first column in FIG. 8, which illustrates rate capability profiles for both electrodes A and B. FIG. 8 shows the different capacity of the prelithiated cathode B in comparison to the electrode A which was a part of a battery cell having a different source of extra lithium to be consumed to prompt formation of the SEI. After the initial delithiation difference, both electrodes performed in a similar manner from cycles 2 to 22. FIGS. 7 and 8 thus illustrate that a prelithiated cathode is capable of at least the same performance throughout the life of a battery cell as a cathode which requires an external source of extra lithium enabling formation of the SEI.

The present disclosure further provides a method of forming the battery cell 10, depicted in FIGS. 2-3B and the cathode depicted in FIGS. 4A-4C. The method may include a step of forming one or more electrodes 14, 16 from one or more slurries or pastes of active materials, binders, solvents, additives, the like, or a combination thereof. The pastes or slurries are fed to one or more coating machines which spread the slurries onto one or more current collector foils 26, 30. The slurry deposition is followed by insertion of the coated foils into an oven to dry. Air drying is also contemplated. The method may also implement calendaring or otherwise pressing the dried slurry onto the foil to achieve desired homogeneity, thickness, porosity, and other properties. Calendaring may be performed after drying.

The method may include adding the sacrificial lithium-containing material 24 during the slurry deposition stage. The sacrificial lithium-containing material 24 is mixed with the cathode slurry so that the cathode material and the sacrificial lithium-containing material 24 are blended and agglomerations of the sacrificial lithium-containing material 24 are formed within the cathodic material 16. The mixture of the sacrificial lithium-containing material 24 and the cathodic material 16 is thus deposited onto the foil at the same time. The method thus includes forming a porous cathode having some of the pores filled with the sacrificial lithium-containing material 24. The resulting cathode 16 is depicted in FIGS. 4A and 4B.

Alternatively, the method includes pre-forming a cathode 16′ from a cathode-only slurry. A prefabricated cathode 16′ is thus formed. The prefabricated cathode 16′ contains cavities or pores 28, at least some of which are accessible. The method employs impregnating one or more accessible pores 28 within the cathode 16′ with the sacrificial lithium-containing material 24 and drying the sacrificial lithium-containing material 24 in the cathode 16′. Some of the pores 28 may be enclosed within the mass of the cathode 16′ and may not be accessible for impregnation purposes. Because the sacrificial lithium-containing material 24 is being inserted into the prefabricated cathode 16′, the method allows precise tailoring of the location of the sacrificial lithium-containing material 24 to be deposited. The ability to control the location and amount of pores to be filled with the sacrificial lithium-containing material 24 enables precise regulation of the porosity within the electrode.

In both cases, the sacrificial lithium-containing material 24 itself may be porous as well, providing spaces for intrusion of the electrolyte 18. Additional spaces may be created upon evaporation of the slurry solvent when open pores between individual particles of the sacrificial lithium-containing material 24 may form.

Furthermore, the method may include controlling porosity of the cathode 16, and thus influencing the efficiency of the battery cell 10, by including a precise amount of the sacrificial lithium-containing material 24 within the cathodic material 16. As the sacrificial lithium-containing material 24 decomposes in response to the first application of charge current to the cell 10, one or more voids or cavities 28 are formed on and/or within the cathodic material 16. The method thus implements fabricating a cathode 16 having a lower amount of porosity than is desirable such that the desirable amount of pores 28 is achieved after the sacrificial lithium-containing material 24 decomposes and forms additional cavities 28. The method includes adjusting the porosity of the cathode 16 by calendaring such that increasing the pressure during the calendaring decreases porosity.

Alternatively still, the method may implement a step of creating a separate layer of the sacrificial lithium-containing material 24. In this embodiment, depicted in FIGS. 3A and 3B, the method may include arranging one or more layers of the sacrificial lithium-containing material 24 adjacent to the cathode 16. The one or more layers of the sacrificial lithium-containing material 24 may be arranged between the cathode 16 and a cathode current collector 26 or between the cathode 16 and the separator 22.

The method also includes preparing a specific electrolyte 18 tailored to provide adequate performance based on the type of the sacrificial lithium-containing material 24 used for the cathode 16 or 16′. The method may further provide supplying a catalyst for the sacrificial lithium-containing material 24 into the cell 10 to initial decomposition of the sacrificial compound 24.

The method implements stacking individually formed components such as the anode 14, the prefabricated cathode 16′, the cathode 16 free of the sacrificial lithium-containing material 24, the cathode 16 including the sacrificial lithium-containing material 24, the sacrificial lithium-containing material 24, the separator 22, into stacks followed by assembling the stacks into cells 10. The cells 10 are then filled with one or more electrolytes which wet the separator 22, soak into the cell 10, and wet the electrodes 14, 16. Other components such as conducting tabs, insulators, seals, safety devices, or the like may be added to the battery cell 10.

The method also includes a step of applying a charge current to the battery cell 10 for the first time and decomposing the sacrificial lithium-containing material 24 in response to the first application of the charge current to the cell 10. The method includes increasing capacity of the battery cell 10 during the initial charge cycle by supplying a sacrificial lithium-containing material 24 on the cathode 16 in comparison to the capacity of a battery not including a sacrificial lithium-containing material 24 on the cathode. The method includes degassing or venting the cell 10 following the first current charge. The method further includes charging and discharging the battery cell 10.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A lithium ion battery cell comprising:
an anode;
a cathode; and
a sacrificial lithium-containing material on the cathode configured to decompose to release lithium ions in response to first application of charge current to the cell to prompt formation of a solid-electrolyte interphase via a reaction of the lithium ions on a surface of the anode adjacent to the cathode.

2. The battery cell of claim 1, wherein the sacrificial lithium-containing material is arranged between the cathode and a cathode current collector.

3. The battery cell of claim 1, wherein the sacrificial lithium-containing material is arranged between the cathode and a separator.

4. The battery cell of claim 1, wherein the sacrificial lithium-containing material is an oxidized lithium compound configured to decompose into a gas and the lithium ions in response to the first application of charge current.

5. The battery cell of claim 4, wherein the oxidized lithium compound is lithium peroxide.

6. The battery cell of claim 1, further comprising a catalyst configured to initialize a decomposition of the sacrificial lithium-containing material.

7. The battery cell of claim 6, wherein the catalyst is cobalt tetraoxide.

8. The battery cell of claim 1, wherein an amount of the sacrificial lithium-containing material corresponds to a theoretical amount of lithium to be consumed by the solid-electrolyte interphase formation during a first battery cell charge cycle.

9. A lithium ion battery cell comprising:
an anode; and
a cathode including sacrificial lithium-containing material configured to decompose to release lithium ions in response to first application of charge current to the cell to prompt formation of a solid-electrolyte interphase via a reaction of the lithium ions on a surface of the anode adjacent to the cathode.

10. The battery cell of claim 9, wherein the sacrificial lithium-containing material is an oxidized lithium compound configured to decompose into a gas and the lithium ions in response to the first application of charge current.

11. The battery cell of claim 9, wherein the cathode comprises cavities, at least some of which include the sacrificial lithium-containing material.

12. The battery cell of claim 9, further comprising a catalyst configured to initialize a decomposition of the sacrificial lithium-containing material.

13. The battery cell of claim 12, wherein the catalyst is cobalt tetraoxide.

14. The battery cell of claim 9, wherein an amount of the sacrificial lithium-containing material corresponds to a theoretical amount of lithium to be consumed by the solid-electrolyte interphase formation during a first battery cell charge cycle.

15. A lithium ion battery cell comprising:
an anode; and
a cathode having a porous structure impregnated with a sacrificial lithium-containing material configured to decompose to release lithium ions in response to first application of charge current to the cell to prompt formation of a solid-electrolyte interphase via a reaction of the lithium ions on a surface of the anode adjacent to the cathode.

16. The lithium ion battery cell of claim 15, wherein an amount of the sacrificial lithium-containing material corresponds to a theoretical amount of lithium to be consumed by the solid-electrolyte interphase formation during a first battery cell charge cycle.

17. The lithium ion battery cell of claim 15, wherein the sacrificial lithium-containing material is an oxidized lithium compound configured to decompose into a gas and the lithium ions in response to the first application of charge current.

18. The lithium ion battery cell of claim 17, wherein the oxidized lithium compound is lithium peroxide.

19. The lithium ion battery cell of claim 15, wherein a decomposition of the sacrificial lithium-containing material increases volume of pores within the porous structure of the cathode.

20. The lithium ion battery cell of claim 15, further comprising a catalyst to initialize a decomposition of the sacrificial lithium-containing material.
